(19) United States
(12) Patent Application Publication
(10) Pub. No.: US 2016/0054163 A1
(43) Pub. Date: Feb. 25, 2016

(54) TOOL FOR METERING SAUCE

(71) Applicant: Pizza Hut, Inc., Plano, TX (US)

(72) Inventors: Eric Walton, Frisco, TX (US); Kevin Murray, Wylie, TX (US); Christopher Michael Raleigh, Baton Rouge, LA (US); Matthew Allen Kirby, Denton, TX (US); Marco Vincente Lopez, Corinth, TX (US)

(21) Appl. No.: 14/830,851

(22) Filed: Aug. 20, 2015

Related U.S. Application Data
(60) Provisional application No. 62/039,741, filed on Aug. 20, 2014.

(51) Int. Cl. G01F 19/00

(52) U.S. Cl. CPC G01F 19/002; G01F 19/005

(57) ABSTRACT

A tool for metering sauce or other materials comprises a handle and a bowl positioned at a distal end of the handle for holding an amount of the sauce or other material. The bowl defines an open top bounded by a rim, and the bowl includes multiple posts extending from a bottom wall, such that a first predetermined volume is defined by filling the bowl to the rim, and a second predetermined volume is defined by filling the bowl such that upper surfaces of the multiple posts are visible. The bowl may further include two ribs extending from a side wall of the bowl, wherein a third predetermined volume is defined by orienting the tool on its side such that the two ribs effectively define a horizontal plane and filling the bowl up to the horizontal plane between the two ribs.

### CROSS-REFERENCE TO RELATED APPLICATIONS

The present application claims priority to U.S. Patent Application Ser. No. 62/039,741 filed on Aug. 20, 2014.

### BACKGROUND OF THE INVENTION

The present invention relates to a tool for metering sauce.

In the process of assembling a pizza, a pizza dough is placed on or spread over a pan, stone, or other cooking implement. Sauce is applied to the top surface of the pizza dough, along with cheese and selected toppings (such as pepperoni, sausage, vegetables, etc.). The pizza is then cooked for a predetermined time period and served.

In a restaurant environment, there are a number of complexities and variables that factor into the process. For instance, varying sizes of pizza are ordinarily available from a restaurant, along with multiple crust types. The amounts of sauce, cheese, and toppings applied to the pizza are dependent on the size of the pizza and/or the type of crust. Furthermore, in a restaurant environment, especially for a restaurant chain with multiple outlets, it is important to ensure that pizzas are served with a consistent quality. In other words, each pizza must be assembled in the same manner, with the amounts of sauce, cheese, and toppings rigidly controlled in order to achieve the desired flavor profile. Furthermore, by controlling the amounts of the sauce, cheese, and toppings for each pizza, cost controls can be realized.

### SUMMARY OF THE INVENTION

The present invention is a tool for metering sauce, which helps ensure that consistent volumes of sauce are applied to each and every pizza assembled.

An exemplary tool for metering sauce made in accordance with the present invention includes a bowl positioned at a distal end of a handle. The bowl defines a substantially cylindrical volume for holding an amount of sauce (or other material). The bowl thus includes a bottom wall (which is substantially flat and thus facilitates the spreading of the sauce across the surface of a pizza crust) and a continuous side wall extending upward from the bottom wall. The side wall defines an open top opposite the bottom wall and bounded by a circular rim.

The bowl also includes three posts that extend from the bottom wall of the bowl and are oriented substantially perpendicular to the bottom wall of the bowl. Each of the three posts terminates with an end having a substantially flat upper surface positioned below the rim of the bowl. In this regard, the posts are all substantially the same height, such that the ends of the posts define a plane which is substantially parallel to the bottom wall and the rim of the bowl.

In some embodiments, the bowl also includes two or more ribs that extend from the side wall of the bowl. For instance, in some embodiments, a front rib is positioned diametrically across the bowl from the handle, and two side ribs are symmetrically positioned on either side of the front rib.

With the tool of the present invention, a first predetermined volume is defined by filling the bowl up to the rim, i.e., completely filling the bowl such that the posts are completely submerged and not visible. A second predetermined volume is then defined by filling the bowl up to the ends of the posts, i.e., such that only the upper surfaces of the ends of the posts are visible. A third predetermined volume is then defined by orienting the tool on its side such that a front rib and a side rib effectively define a horizontal plane and filling the bowl up to the horizontal plane between the front rib and the side rib.

With respect to the posts and the ribs, it should be noted that such components are preferably arranged symmetrically to allow both right-handed and left-handed individuals to use the tool.

In assembling a pizza, various volumes of sauce can thus be readily applied to a pizza. As discussed above, there are three predetermined volumes that can be metered with the bowl of the tool. However, combinations of these three predetermined volumes are also possible.

Finally, although the application of sauce to a pizza is one preferred use of the tool, the tool certainly can also be used to meter and dispense other food products or even non-food materials, including liquid or granular materials.

### DESCRIPTION OF THE DRAWINGS

FIG. 1 is a perspective view of an exemplary tool made in accordance with the present invention;

FIG. 2 is an enlarged, partial perspective view of the exemplary tool of FIG. 1 with a portion of the side wall cut away to show the interior of the bowl;

FIG. 3 is an enlarged, partial perspective view of the exemplary tool of FIG. 1 with the bowl completely filled to a first predetermined volume;

FIG. 4 is an enlarged, partial perspective view of the exemplary tool of FIG. 1 with the bowl partially filled to a second predetermined volume; and

FIG. 5 is an enlarged perspective view of the exemplary tool of FIG. 1 with the tool oriented on its side and with the bowl partially filled to a third predetermined volume.

### DETAILED DESCRIPTION OF THE INVENTION

The present invention is a tool for metering sauce, which helps ensure that consistent volumes of sauce are applied to each and every pizza.

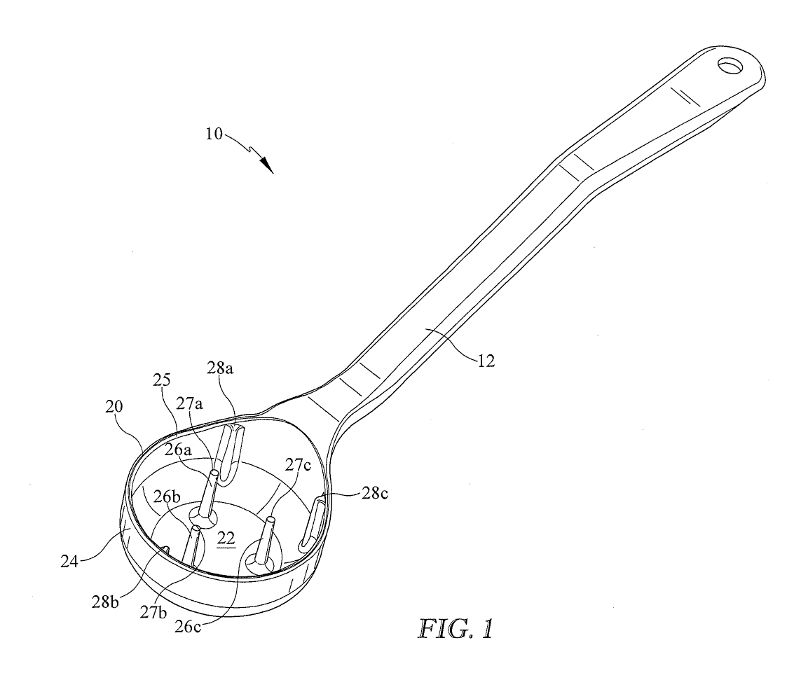

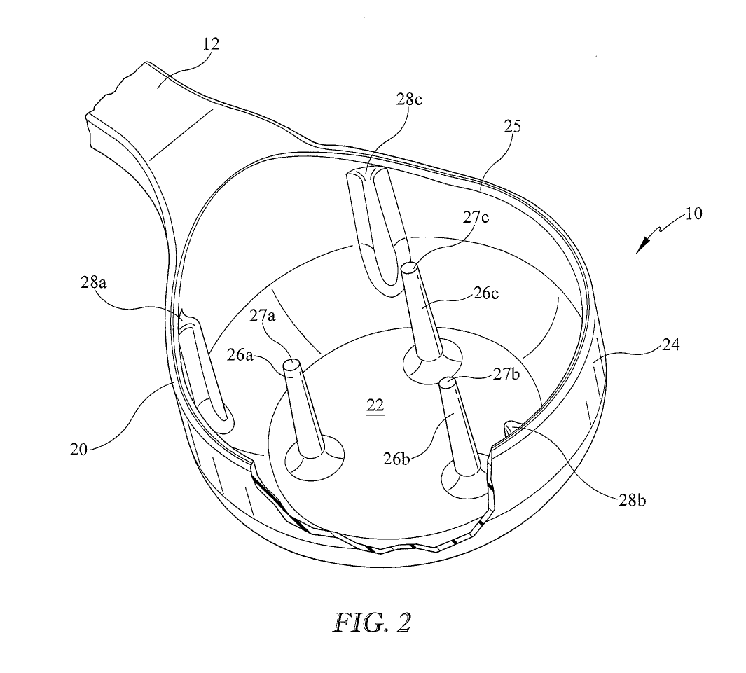

Referring now to FIGS. 1 and 2, an exemplary tool 10 for metering sauce made in accordance with the present invention includes a bowl 20 positioned at a distal end of a handle 12. In this exemplary embodiment, the bowl 20 defines a substantially cylindrical volume for holding an amount of sauce (or other material). The bowl 20 thus includes a bottom wall 22 (which is substantially flat and thus facilitates the spreading of the sauce across the surface of a pizza crust) and a continuous side wall 24 extending upward from the bottom wall 22. The side wall 24 defines an open top opposite the bottom wall 22 and bounded by a circular rim 25. However, the bowl 20 could also define other volumetric shapes, including, for example, cubes or rectangular prisms, without departing from the spirit and scope of the present invention.

Referring still to FIGS. 1 and 2, in this exemplary embodiment, the bowl 20 also includes three posts 26a, 26b, 26c that extend from the bottom wall 22 of the bowl 20 and are oriented substantially perpendicular to the bottom wall 22 of the bowl 20. Each of the three posts 26a, 26b, 26c terminates with an end 27a, 27b, 27c having a substantially flat upper surface positioned below the rim 25 of the bowl. In this exemplary embodiment, the posts 26a, 26b, 26c are all substantially the same height, and because there are three posts, the ends 27a, 27b, 27c of the posts 26a, 26b, 26c define a plane which is substantially parallel to the bottom wall 22 and the rim 25 of the bowl, as further discussed below. Furthermore, in this exemplary embodiment, the posts 26a, 26b, 26c are located near the middle of the bowl 20 and positioned approximately 120° from one another (if a circle was drawn through the posts 26a, 26b, 26c). In other words, each of the posts 26a, 26b, 26c is positioned approximately equidistant from one another, and the posts 26a, 26b, 26c form an equilateral triangle. Of course, the bowl 20 could include different numbers and arrangements of posts, without departing from the spirit and scope of the present invention, as will become clear from the description that follows.

Referring still to FIGS. 1 and 2, in this exemplary embodiment, the bowl 20 also includes two or more (e.g., three) ribs 28a, 28b, 28c that extend from the side wall 24 of the bowl 20. In this exemplary embodiment, a front rib 28b is positioned diametrically across the bowl 20 from the handle 12, and two side ribs 28a, 28c are symmetrically positioned on either side of the front rib 28b. Specifically, in this exemplary embodiment, the front rib 28b and one of the two side ribs 28a are separated by approximately 140°, and the front rib 28b and the other of the two side ribs 28c are similarly separated by approximately 140°, as further discussed below. Of course, the bowl 20 could include different numbers and arrangements of ribs without departing from the spirit and scope of the present invention.

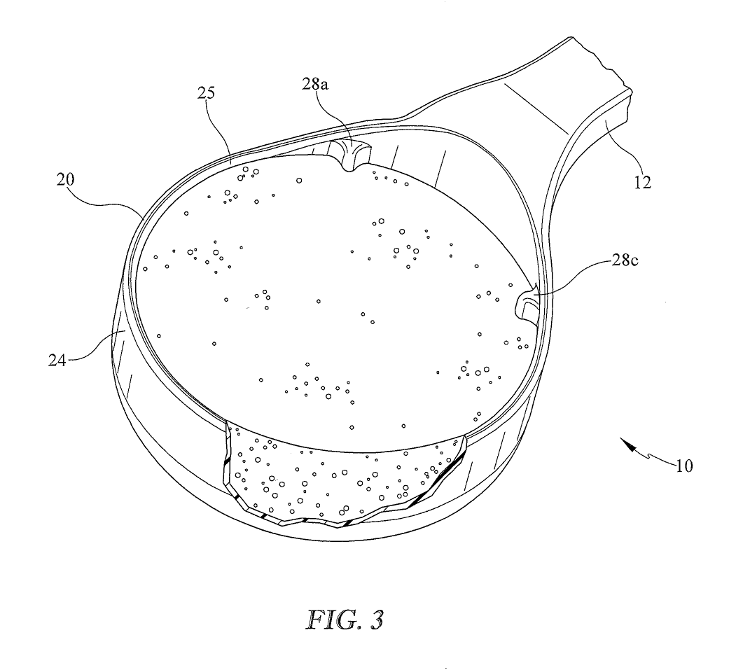

Referring now to FIG. 3, a first predetermined volume is defined by filling the bowl 20 up to the rim 25, i.e., completely filling the bowl 20. As shown in FIG. 3, because the ends 27a, 27b, 27c of the posts 26a, 26b, 26c are positioned below the rim 25 of the bowl, when the first predetermined volume is filled with sauce, the posts 26a, 26b, 26c are completely submerged and not visible.

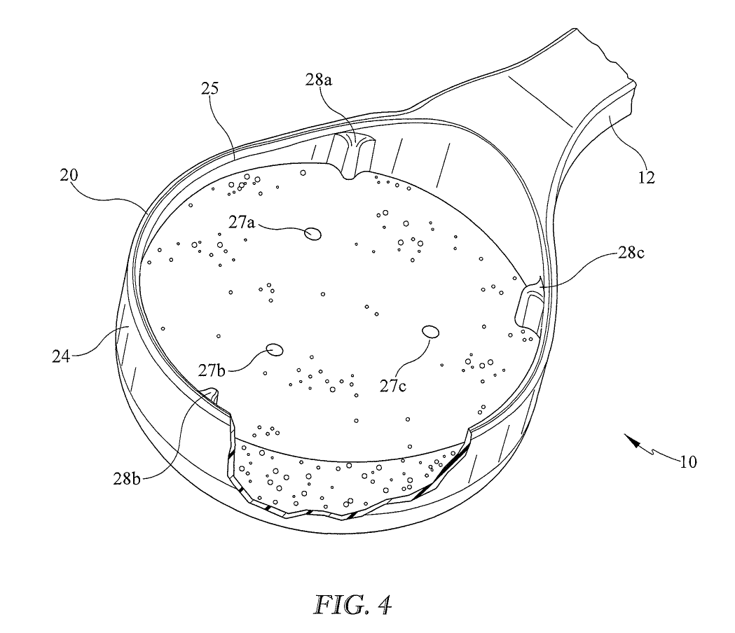

Referring now to FIG. 4, through use of the three posts 26a, 26b, 26c, a second predetermined volume is defined by filling the bowl 20 up to the ends 27a, 27b, 27c of the posts 26a, 26b, 26c, i.e., such that only the upper surfaces of the ends 27a, 27b, 27c of the posts 26a, 26b, 26c are visible. In practice, the bowl 20 can be inserted into a container of sauce (or other material), and then gently shaken to remove some sauce from the bowl 20. Once the sauce settles in the bowl 20, the level of the sauce relative to the posts 26a, 26b, 26c can be visually assessed by the individual tasked with applying the sauce to a pizza crust. As discussed above, the ends 27a, 27b, 27c of the posts 26a, 26b, 26c define a plane which is substantially parallel to the bottom wall 22 and the rim 25 of the bowl 20, which provides a simple visual check that the bowl 20 is being held level. In other words, and as shown in FIG. 4, when the second predetermined volume is filled with sauce, all three of the ends 27a, 27b, 27c are visible, and no other portion of the posts 26a, 26b, 26c is visible. If the bowl were slightly tipped, one or more of the ends 27a, 27b, 27c would not be visible and a portion of one or more of the posts 26a, 26b, 26c other than then ends 27a, 27b, 27c would also be visible.

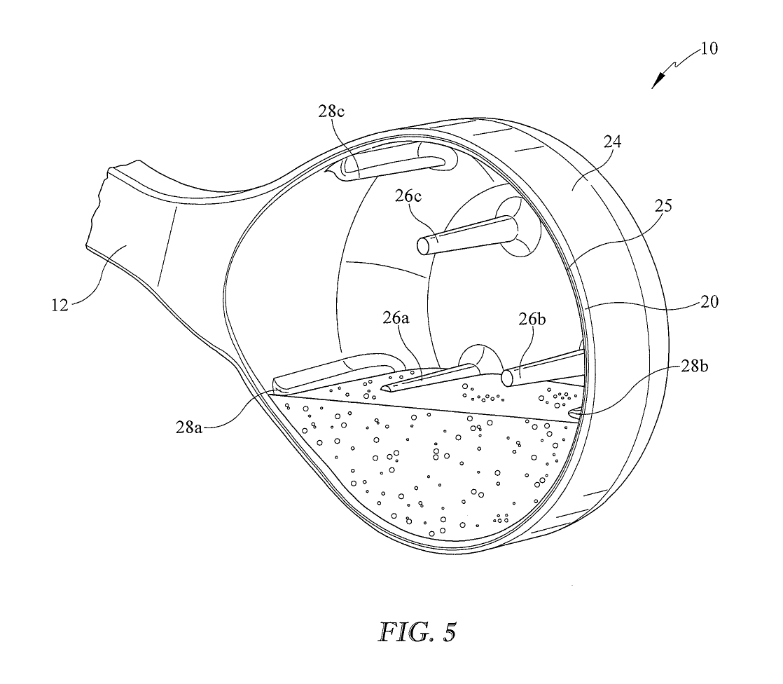

Referring now to FIG. 5, a third predetermined volume is defined by orienting the tool 10 on its side such that two of the ribs 28a, 28b effectively define a horizontal plane and filling the bowl up to the horizontal plane between the two ribs 28a, 28b. In this exemplary embodiment, the front rib 28b and the side rib 28a are separated by approximately 140°.

With respect to the posts 26a, 26b, 26c and the ribs 28a, 28b, 28c, it should be noted that, in the exemplary embodiment shown in FIGS. 1 and 2, such components are arranged symmetrically to allow both right-handed and left-handed individuals to use the tool 10. For example, the third predetermined volume can similarly be defined by orienting the tool 10 on the opposite side shown in FIG. 5, such that two of the ribs 28b, 28c define a horizontal plane and filling the bowl up to the two ribs 28b, 28c.

In assembling a pizza, various volumes of sauce can thus be readily applied to a pizza. As discussed above, there are three predetermined volumes that can be metered with the bowl 20 of the tool 10. However, combinations of these three predetermined volumes are also possible to make different types of pizza. For example, Table A illustrates how to use the tool 10 to meter and apply five different volumes of sauce:

TABLE A

| Predetermined | |
|---|---|
| Volume | |
| 1 | Fill the bowl 20 up to the rim 25. |
| 2 | Fill the bowl 20 such that only the ends 27a, 27b, 27c |
| | of the posts 26a, 26b, 26c are visible. |
| 3 | Fill an area of the bowl 20 up to two of the ribs 28a, |
| | 28b, 28c. |
| 4 | Predetermined Volume 1 + Predetermined Volume 3 |
| 5 | Predetermined Volume 2 + Predetermined Volume 3 |

As should be clear from the above description, the tool 10 also ensures that consistent volumes of sauce are applied to each and every pizza assembled, which again is important to achieve the desired flavor profile and to control costs. Furthermore, minimal training is necessary to instruct those individuals tasked with assembling each pizza as to the proper use of the tool 10, which further ensures that a consistent flavor profile is achieved.

As briefly mentioned above, the use of the tool 10 is not limited to the application of sauce to a pizza. Although the application of sauce to a pizza is one preferred use of the tool 10, the tool 10 certainly can be used to meter and dispense other food products or even non-food materials, including liquid or granular materials, without departing from the spirit and scope of the present application.

One of ordinary skill in the art will recognize that additional embodiments are possible without departing from the teachings of the present invention or the scope of the claims which follow. This detailed description, and particularly the specific details of the exemplary embodiment disclosed herein, is given primarily for clarity of understanding, and no unnecessary limitations are to be understood therefrom, for modifications will become obvious to those skilled in the art upon reading this disclosure and may be made without departing from the spirit or scope of the claimed invention.

What is claimed is:

1. A tool for metering sauce, comprising:
a handle;
a bowl positioned at a distal end of the handle for holding an amount of sauce, said bowl defining an open top bounded by a rim; and
one or more posts extending from a bottom wall of the bowl, with respective ends of the one or more posts positioned below the rim of the bowl;
wherein a first predetermined volume is defined by filling the bowl up to the rim of the bowl; and
wherein a second predetermined volume is defined by filling the bowl up to the ends of the one or more posts.

2. The tool as recited in claim 1, wherein three posts extend from the bottom wall of the bowl, such that the ends of the three posts define a plane substantially parallel to the bottom wall and the rim of the bowl.

3. The tool as recited in claim 2, wherein the three posts are positioned approximately 120° from one another.

4. The tool as recited in claim 2, wherein the three posts are positioned approximately equidistant from one another.

5. The tool as recited in claim 1, wherein the bowl further includes two ribs extending from a side wall of the bowl, and wherein a third predetermined volume is defined by orienting the tool on its side such that the two ribs effectively define a horizontal plane and filling the bowl up to the horizontal plane between the two ribs.

6. The tool as recited in claim 1, wherein the bowl further includes a front rib positioned diametrically across the bowl from the handle and two side ribs symmetrically positioned on either side of the front rib, such that a third predetermined volume is defined by orienting the tool on its side such that the front rib and one of the two side ribs effectively define a horizontal plane and filling the bowl up to the horizontal plane between the front rib and the one of the two side ribs.

7. The tool as recited in claim 6, wherein the two side ribs are symmetrically positioned approximately 140° on either side of the front rib.

8. A tool for metering sauce, comprising:
a handle; and
a bowl positioned at a distal end of the handle for holding an amount of sauce, said bowl defining an open top bounded by a rim, and said bowl having a bottom wall and a side wall extending upward from the bottom wall;
a front rib extending from the side wall of the bowl diametrically across the bowl from the handle; and
two side ribs extending from the side wall of the bowl, said two side ribs being symmetrically positioned approximately 140° on either side of the front rib;
wherein a first predetermined volume is defined by filling the bowl up to the rim of the bowl; and
wherein a second predetermined volume is defined by orienting the tool on its side such that the front rib and one of the two side ribs effectively define a horizontal plane and filling the bowl up to the horizontal plane between the front rib and the one of the two side ribs.

9. The tool as recited in claim 8, wherein the bowl further includes one or more posts extending from the bottom wall of the bowl and with ends positioned below the rim of the bowl, and wherein a third predetermined volume is defined by filling the bowl up to the ends of the one or more posts.

10. A tool for metering sauce, comprising:
a handle; and
a bowl positioned at a distal end of the handle for holding an amount of sauce, said bowl defining an open top bounded by a rim;
three posts extending from a bottom wall of the bowl, with respective ends of the three posts positioned below the rim of the bowl;
two ribs extending from a side wall of the bowl;
wherein a first predetermined volume is defined by filling the bowl up to the rim of the bowl;
wherein a second predetermined volume is defined by filling the bowl up to the ends of the three posts; and
wherein a third predetermined volume is defined by orienting the tool on its side such that the two ribs effectively define a horizontal plane and filling the bowl up to the horizontal plane between the two ribs.

11. The tool as recited in claim 10, wherein the ends of the three posts define a plane substantially parallel to the bottom wall and the rim of the bowl.

12. A tool for metering a material, comprising:
a handle; and
a bowl positioned at a distal end of the handle for holding an amount of the material, said bowl defining an open top bounded by a rim, and said bowl including multiple posts extending from a bottom wall, such that a first predetermined volume is defined by filling said bowl to the rim, and a second predetermined volume is defined by filling said bowl such that upper surfaces of the multiple posts are visible.

13. The tool as recited in claim 12, wherein the bowl further includes two ribs extending from a side wall of the bowl, and wherein a third predetermined volume is defined by orienting the tool on its side such that the two ribs effectively define a horizontal plane and filling the bowl up to the horizontal plane between the two ribs.

14. The tool as recited in claim 12, wherein the material is a liquid material.

15. The tool as recited in claim 12, wherein the material is a granular material.

16. The tool as recited in claim 12, wherein the material is a food product.
